(19) United States
(12) Patent Application Publication
(10) Pub. No.: US 2012/0099737 A1
(43) Pub. Date: Apr. 26, 2012

(54) Apparatus And Methods

(75) Inventors: Tomas Ivaskevicius, Helsinki (FI); Juha Kosonen, Porvoo (FI)

(73) Assignee: Nokia Corporation

(21) Appl. No.: 12/908,244

(22) Filed: Oct. 20, 2010

(51) Int. Cl. H04R 1/10

(52) U.S. Cl. 381/74

(57) ABSTRACT

An apparatus including: a body including a first surface defining an aperture; and an audio output device configured to pivot relative to the body between at least a first position in which the audio output device is at least partially positioned within the aperture, and a second position in which the audio output device extends from the first surface.

### TECHNOLOGICAL FIELD

Embodiments of the present invention relate to apparatus and methods. In particular, they relate to apparatus in a headset.

### BACKGROUND

Apparatus, such as portable electronic communication devices, usually include an audio output device for providing sound to a user. For example, where the apparatus is used to conduct a telephone conversation, the user may hold the apparatus to his head so that the audio output device is positioned adjacent his ear.

In some circumstances, it may be inconvenient or dangerous for the user to hold the apparatus to his head. For example, if the user is driving a motor vehicle, holding the apparatus may reduce the user's control of the vehicle.

It would therefore be desirable to provide an alternative apparatus.

### BRIEF SUMMARY

According to various, but not necessarily all, embodiments of the invention there is provided an apparatus comprising: a body comprising a first surface defining an aperture; and an audio output device configured to pivot relative to the body between at least a first position in which the audio output device is at least partially positioned within the aperture, and a second position in which the audio output device extends from the first surface.

The aperture may be a blind aperture.

The body may include a second surface defining the aperture, and the aperture may extend between the first surface and the second surface. The audio output device may be configured to pivot relative to the body to a third position in which the audio output device extends from the second surface.

The first surface may have a first characteristic and the second surface may have a second characteristic, which may be different to the first characteristic.

The aperture may be configured to receive a strap to enable the apparatus to be worn around a user's neck.

The apparatus may further comprise a data input apparatus configured to receive data. The data input apparatus may comprise one or more of: a wireless receiver configured to receive electromagnetic signals, and a connector configured to physically connect with a further apparatus to receive signals.

The apparatus may further comprise a memory configured to store data received from the data input apparatus.

The apparatus may further comprise a fastener configured to fasten the apparatus to a garment of a user.

The fastener may comprise a user input device configured to enable a user to control the apparatus.

According to various, but not necessarily all, embodiments of the invention there is provided a headset comprising an apparatus as described in any of the preceding paragraphs.

According to various, but not necessarily all, embodiments of the invention there is provided a method comprising: providing a body comprising a first surface defining an aperture; and providing an audio output device configured to pivot relative to the body between at least a first position in which the audio output device is at least partially positioned within the aperture, and a second position in which the audio output device extends from the first surface.

The aperture may be a blind aperture.

The body may include a second surface defining the aperture, and the aperture may extend between the first surface and the second surface.

The audio output device may be configured to pivot relative to the body to a third position in which the audio output device extends from the second surface.

The aperture may be configured to receive a strap to enable at least the body and the audio output device to be worn around a user's neck.

The method may further comprise providing a data input apparatus configured to receive data. The data input apparatus may comprise one or more of: a wireless receiver configured to receive electromagnetic signals, and a connector configured to physically connect with a further apparatus to receive signals.

The method may further comprise providing a fastener configured to fasten at least the body and the audio output device to a garment of a user.

The fastener may comprise a user input device configured to enable a user to provide a control input.

The method may further comprise assembling at least the body and the audio output device to form a head set.

### BRIEF DESCRIPTION

For a better understanding of various examples of embodiments of the present invention reference will now be made by way of example only to the accompanying drawings in which:

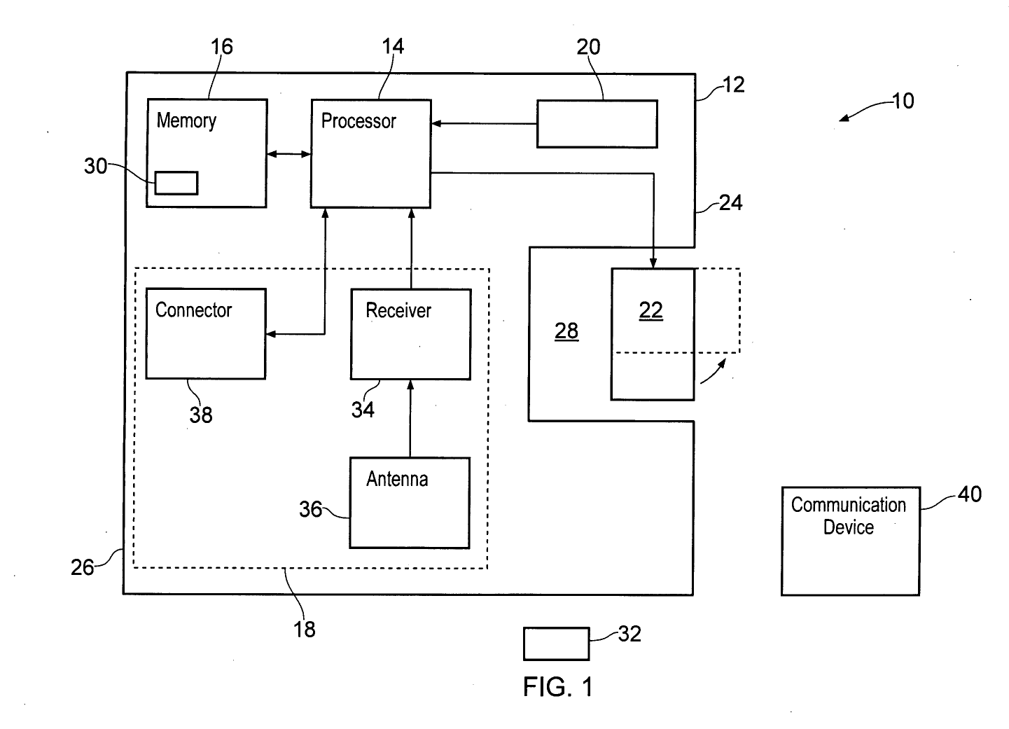

FIG. 1 illustrates a schematic diagram of an apparatus according to various embodiments of the invention;

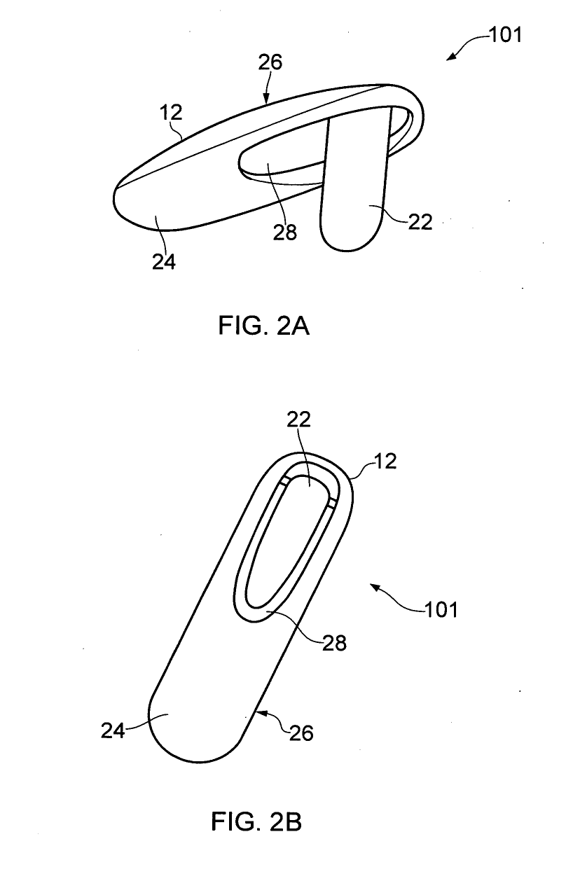

FIGS. 2A & 2B illustrate perspective views of a first apparatus according to various embodiments of the invention;

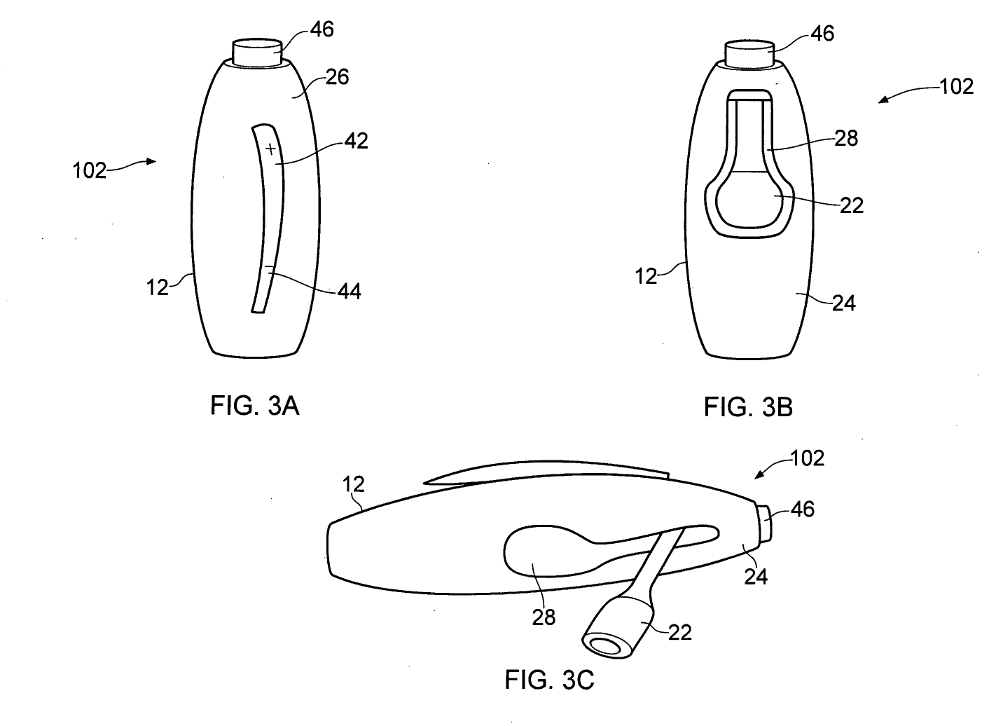

FIGS. 3A, 3B & 3C illustrate perspective views of a second apparatus according to various embodiments of the invention;

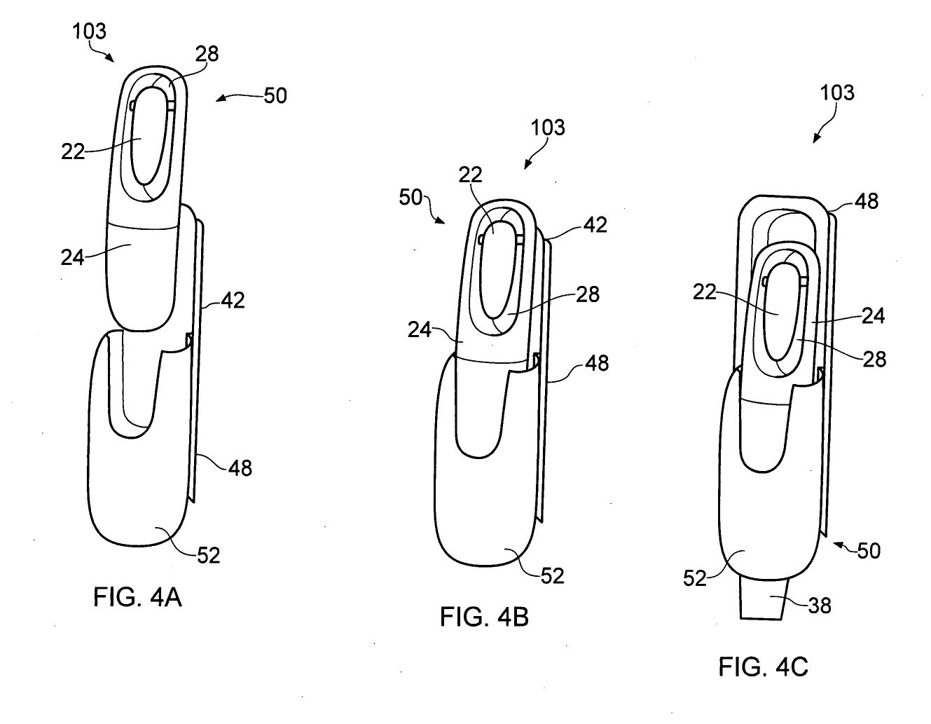

FIGS. 4A, 4B & 4C illustrate perspective views of a third apparatus according to various embodiments of the invention;

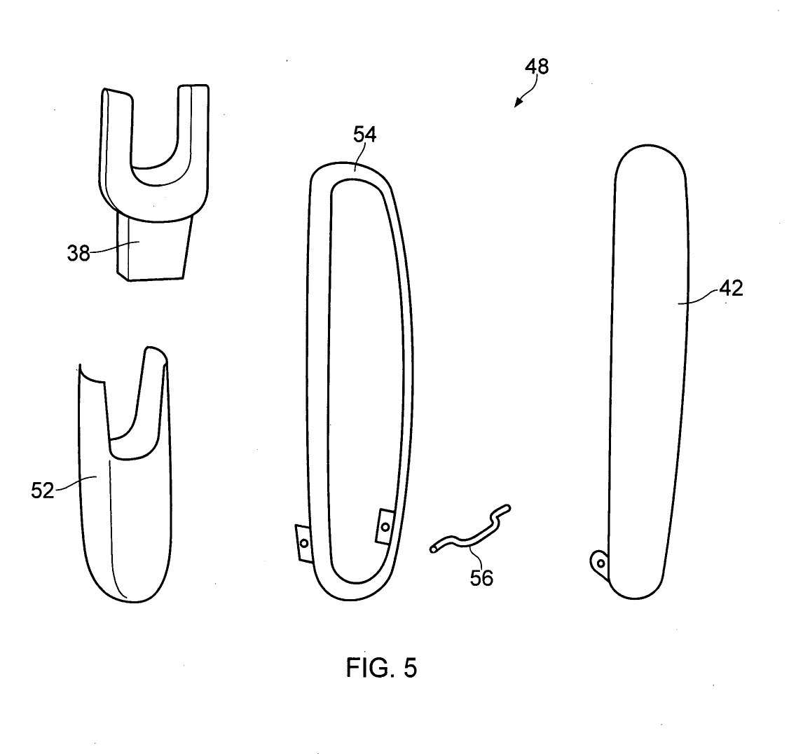

FIG. 5 illustrates an exploded view of a first part of the third apparatus illustrated in FIGS. 4A, 4B & 4C;

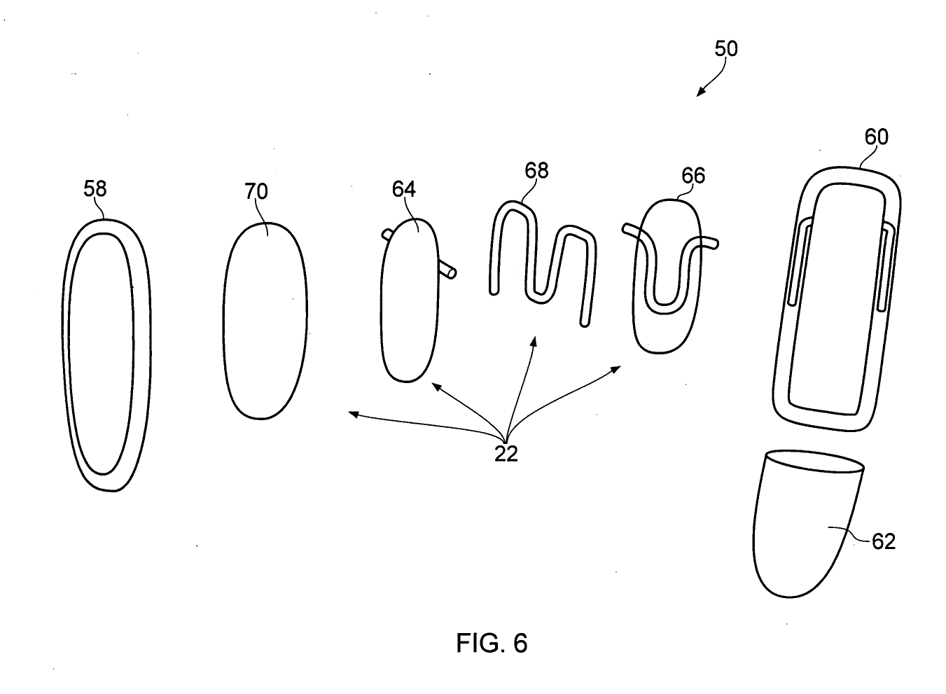

FIG. 6 illustrates an exploded view of a second part of the third apparatus illustrated in FIGS. 4A, 4B & 4C;

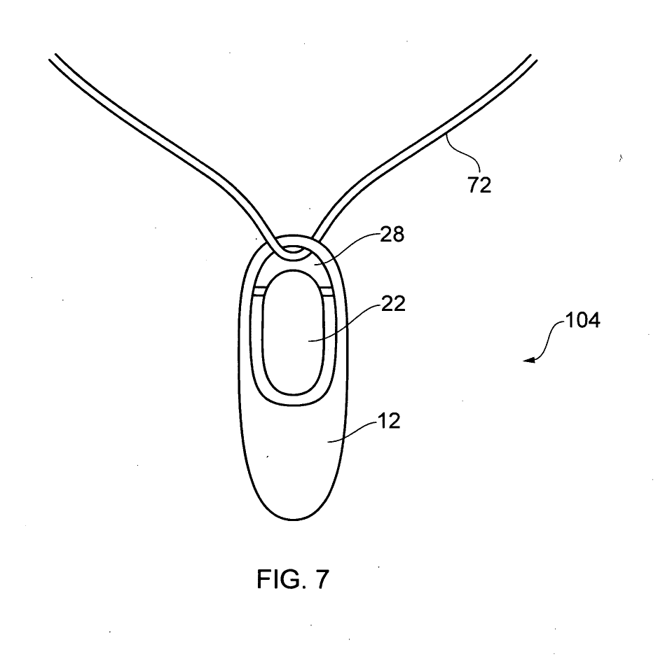

FIG. 7 illustrates a perspective view of a fourth apparatus according to various embodiments of the invention; and

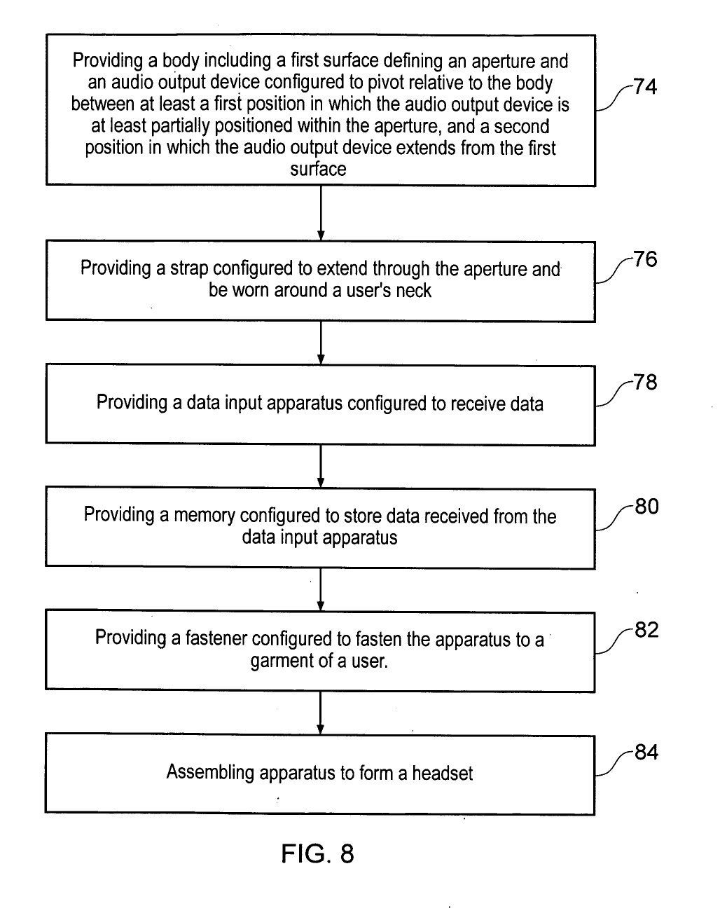

FIG. 8 illustrates a flow diagram of a method according to various embodiments of the invention.

### DETAILED DESCRIPTION

In the following description, the wording ‘connect’ and ‘couple’ and their derivatives mean operationally connected or coupled. It should be appreciated that any number or combination of intervening components can exist (including no intervening components).

FIGS. 1 to 7 illustrate an apparatus 10 comprising: a body 12 including a first surface 24 defining an aperture 28; and an audio output device 22 configured to pivot relative to the body 12 between at least a first position in which the audio output device 22 is at least partially positioned within the aperture 28, and a second position in which the audio output device 22 extends from the first surface 24.

In more detail, FIG. 1 illustrates a schematic diagram of an apparatus 10 according to various embodiments of the invention. The apparatus 10 includes a body, a processor 14, a memory 16, a data input apparatus 18, an audio input device 20 and an audio output, device 22.

The apparatus 10 may be a portable communication device such as a mobile cellular telephone or a headset. Alternatively, the apparatus 10 may be a module for such devices. As used here ‘module’ refers to a unit or apparatus that excludes certain parts/components that would be added by an end manufacturer or a user. For example, where the apparatus 10 is a module, the apparatus 10 may only include the body 12 and the audio output device 22.

The body 12 at least partially defines the exterior surface of the apparatus 10 and provides a housing for at least some of the components of the apparatus 10 (for example, the body 12 may house the processor 14, the memory 16 and so on). The body 12 may comprise any suitable material and may comprise one or more plastics and/or one or more metals.

The body 12 includes a first exterior surface 24 and a second exterior surface 24. The first surface 24 defines an aperture 28 which may be a blind aperture (that is, the aperture 28 does not extend through the body 12 and consequently defines an opening, recess or cavity in the body). In other embodiments, the aperture 28 may be an aperture that extends through the body 12 between the first and second surfaces 24, 26 and consequently defines a hole in the body 12.

The processor 14 may be any suitable processor (for example, a microprocessor), controller or circuitry and may include a plurality of processors and/or controllers and/or circuits. The implementation of the processor 14 can be in hardware alone (for example, a circuit), have certain aspects in software including firmware alone or can be a combination of hardware and software (including firmware).

The processor 14 may, be implemented using instructions that enable hardware functionality, for example, by using executable computer program instructions in a general-purpose or special-purpose processor that may be stored on a computer readable storage medium (disk, memory and so on) to be executed by such a processor.

The processor 14 is configured to read from and write to the memory 16. The processor 14 may also comprise an output interface via which data and/or commands are output by the processor 14 and an input interface via which data and/or commands are input to the processor 14.

The memory 16 may be any suitable memory and may include flash memory and/or random access memory (RAM). The memory 16 stores a computer program 30 comprising computer program instructions that control the operation of the apparatus 10 when loaded into the processor 14. The computer program instructions provide the logic and routines that enables the apparatus 10 to perform the methods mentioned below. The processor 14 by reading the memory 16 is able to load and execute the computer program 30.

The computer program 30 may arrive at the apparatus 10 via any suitable delivery mechanism 32. The delivery mechanism 32 may be, for example, a computer-readable storage medium, a computer program product, a memory device or an article of manufacture that tangibly embodies the computer program 30. The delivery mechanism 32 may be a signal configured to reliably transfer the computer program 30.

Although the memory 16 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ and so on, or a ‘controller’, ‘computer’, ‘processor’ and so on, should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code and so on should be understood to encompass software for a programmable processor or firmware such as, for example, the programmable content of a hardware device whether instructions for a processor, or configuration settings for a fixed-function device, gate array or programmable logic device and so on.

As used in this application, the term ‘circuitry’ refers to all of the following:

(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The data input apparatus 18 is configured to receive data (from an external device for example) and provide the data to the processor 14 for processing. The data input apparatus 18 includes a receiver 34, an antenna 36 and/or a connector 38.

The antenna 36 is configured to receive electromagnetic signals. The receiver 34 is configured to receive the signals from the antenna 36 and decode the received signals and then provide the decoded signals to the processor 14 for processing. In some embodiments, the receiver 34 may be a transceiver and the apparatus 10 may also be configured to transmit signals. The antenna 36 and the receiver 34 may be configured to operate using any suitable wireless protocol. For example, the antenna 36 and the receiver 34 may be configured to operate using Bluetooth or Wi-Fi.

In other embodiments, the receiver 34 and the antenna 36 may be replaced with a direct electrical connection (that is, a wired connection) and may include one or more wires and associated circuitry for receiving (and optionally transmitting) data. In these embodiments, the apparatus 10 may be a wired headset.

The connector 38 may be any suitable interface for receiving and/or transmitting data. The connector 38 is configured to receive data and provide the data to the processor 14 for subsequent storage in the memory 16. The connector 38 is also configured to transmit signals sent from the processor 14. The connector 38 may be, for example, a Universal Serial Bus (USB) connector or a High Definition Multimedia Interface (HDMI) connector.

The audio input device 20 is configured to receive and convert acoustic waves into an electrical signal and provide the electrical signal to the processor 14 for processing. The audio input device 20 may be any transducer which converts acoustic waves into an electrical signal and may be a microphone for example.

The audio output device 22 may be any suitable transducer for converting an electrical signal into acoustic waves and may include a loudspeaker for example. The audio output device 22 may be sized and shaped for being placed adjacent or inside a user's ear. The audio output device 22 is configured to receive audio signals from the processor 14 and convert the audio signals into acoustic waves.

The audio output device 22 is pivotally coupled to the body 12. The audio output device 22 is configured to pivot relative to the body 12 between at least a first position (indicated by the solid lines) in which the audio output device 22 is at least partially positioned within the aperture 28, and a second position (indicated by the dashed lines) in which the audio output device 22 extends from the first surface 34.

The audio output device 22 may be resiliently biased towards the first position so that the apparatus 10 may clip to the user's head when the audio output device 22 is placed in, or adjacent, the user's ear. In various embodiments, the audio output device 22 may be coupled to the body 12 via a resilient member such as a spring (a torsion spring for example) that is resiliently biased to move the audio output device 22 towards the first position. The resilient member may be configured to have a predetermined tension when the audio output device 22 is in a predetermined position relative to the body 12 that firmly clips the audio output device 22 to the user's ear, but does not hurt the user. Consequently, various embodiments may provide an advantage in that the apparatus 10 may be relatively comfortable to wear and may clip firmly to the user's head.

In operation, the audio output device 22 may be pivoted (by the user for example) from the first position to the second position where it may be placed adjacent or inside a user's ear for use. The user may operate a communication device 40 (for example, a portable communication device such as a mobile cellular telephone) to conduct a telephone call with a user of a further communication device.

The communication device 40 may receive voice signals from the further communication device and transmit them to the apparatus 10. The antenna 36 may receive the voice signals from the communication device 40 and provide them to the receiver 34. The receiver 34 decodes the received voice signals and then provides the decoded voice signals to the processor 14 which in turn provides the voice signals to the audio output device 22. The audio output device 22 converts the voice signals into acoustic waves which are then received by the user.

Where the apparatus 10 includes a transceiver 34 and the audio input device 20, the audio input device 20 may receive acoustic waves (the user's voice for example) and convert the acoustic waves into an electrical signal which is provided to the processor 14. The processor 14 provides the electrical signal to the transceiver 34 which encodes the electrical signals and provides the encoded signal to the antenna 36. The antenna 36 transmits the encoded signal to the communication device 40 which then receives and transmits the signal to the further communication device so that the user of the further communication device may receive the signals and listen to them.

After use, the audio output device 22 may then be returned to the first position.

Various embodiments of the present invention provide an advantage in that when the audio output device 22 is in the first position, the body 12 may protect the audio output device 22 from damage (for example, from being knocked by the user) and from picking up dirt. Consequently, various embodiments of the present invention may provide an advantage in that the audio output device 22 may be less likely to be damaged and may be more hygienic.

In the embodiments where the aperture 28 forms a through hole in the body 12 between the first and second surfaces 24, 26, the audio output device 22 may be configured to pivot relative to the body 12 to a third position in which the audio output device 22 extends from the second surface 26. When the audio output device 22 is in the third position, the audio output device 22 may be positioned adjacent or inside a user's ear. This may advantageously enable a user to use the apparatus 10 in either of his ears since the audio output device 22 may be pivoted between extending from the first surface 24 for one ear, to extending from the second surface 26 for the other ear.

The first surface 24 may have one or more characteristics which are different to the characteristics of the second surface 26. Characteristics include the color or colors of the surface, the pattern or patterns of the surface, and the texture or textures of the surface. For example, in one embodiment the first surface may be plain black with a matt texture and the second surface may have a pattern which includes a plurality of colors and may be shiny. If the user wishes to use the apparatus 10 for business, he may pivot the audio output device 22 to the third position (that is, extending from the second surface 26) so that the first surface 24 is visible to other people and so that the second surface 26 is concealed next to his head. If the user wishes to use the apparatus 10 for leisure, he may pivot the audio output device 22 to the second position (that is, extending from the first surface 24) so that the second surface 26 is visible to other people and so that the first surface 24 is concealed next to the user's head. Consequently, various embodiments may advantageously enable the user to the use the apparatus 10 in different circumstances.

FIGS. 2A and 2B illustrate perspective views of a first apparatus 101 according to various embodiments of the invention. The first apparatus 101 is similar to the apparatus 10 illustrated in FIG. 1 and where the features are similar, the same reference numerals are used.

The body 12 has an elongate shape where the length is greater than the width, and the width is greater than the depth. The first exterior surface 24 and second exterior surface 26 are on opposite sides of the body 12 and define the length and width of the body 12.

The aperture 28 forms a through hole in the body 12 between the first and second surfaces 24, 26 and has a length that is approximately half of the length of the body 12 and has a width that is less than the width of the body 12. Consequently, the body 12 forms a loop shape around the aperture 28.

The audio output device 28 is positioned within the aperture 28 and has an elongate shape with a length that is less than the length of the aperture 28 and a width that is less than the width of the aperture 28. The audio output device 28 is pivotally coupled to the body 12 inside the aperture 28 via two ball and socket joints which are provided on opposite longitudinal surfaces of the audio output device 22. As described above, the audio output device 22 may be resiliently biased towards the first position so that the apparatus 10 may clip to the user's head when the audio output device 22 is placed in, or adjacent, the user's ear.

As described above with reference to FIG. 1, the audio output device 22 is pivotable between the first, second and third positions. FIG. 2A illustrates the audio output device 22 in the second position where it extends from the first surface 24 of the body 12. FIG. 2B illustrates the audio output device 22 in the first position where it is positioned within the aperture 28. The audio output device 22 is also pivotable to the third position (not illustrated in FIGS. 2A and 2B) where it extends from the second surface 26 of the body 12. The audio output device 22 may be pivoted through one hundred and eighty degrees so that it may extend from first surface 24 or the second surface 26. It should be appreciated that the audio output device 22 may be pivoted through more or less than one hundred and eighty degrees in other embodiments.

FIGS. 3A, 3B and 3C illustrate perspective views of a second apparatus 102 according to various embodiments of the invention. The second apparatus 102 is similar to the apparatus 10 and the first apparatus 101 and where the features are similar, the same reference numerals are used.

As illustrated in FIG. 3A, the second apparatus 102 includes a fastener 42 which is configured to fasten the second apparatus 102 to a garment of a user. In the illustrated embodiment, the fastener 42 is a clip which has one end attached to the top of the second surface 26 of the body 12 and extends down the length of the body 12 until the opposite end. The clip is resiliently biased towards the second surface 26 and is configured to firmly fasten to a garment placed between the clip 42 and the second surface 26.

It should be appreciated that in other embodiments, the fastener may take other forms. For example, the fastener 42 may be formed by a pin and a corresponding hole in the body 12. In this example, the second apparatus 102 may be fastened to a garment by pushing the pin through a part of a garment and into the hole in the body 12 (thereby fastening the garment between the pin and the body 12).

The fastener 42 includes a user input device 44 which is configured to enable a user to control the second apparatus 102. For example, the user input device 44 may be configured to control the audio output volume of the audio output device 22 or the bass or treble settings of the audio output device 22. The user input device 44 is configured to provide control signals to the processor 14 which in turn controls one or more components of the apparatus (for example, the volume of the audio output device 22). In this embodiment, the user input device 44 includes a first touch sensor (which may be a capacitive or a resistive touch sensor) located at one end of the fastener 42 (indicated with a ‘+’ in the figure), and a second touch sensor (which may be a capacitive or a resistive touch sensor) located at the opposite end of the fastener 42 (indicated with a ‘-’ in the figure). If the user wishes to increase the volume of the audio output device 22, he may press the first touch sensor, and if he wishes to decrease the volume of the audio output device 22, he may press the second touch sensor.

As illustrated in FIGS. 3A and 3B, the aperture 28 is a blind aperture and does not extend through to the second surface 26 of the body 12. The audio output device 22 is pivotally coupled to the body 12 inside the aperture 28 and includes an elongate stem that extends from the coupling point and an earpiece that is coupled to the end of the stem. The stem and the earpiece have a cylindrical shape and the diameter of the earpiece is greater than the diameter of the stem. The shape of the aperture 28 corresponds to the shape of the audio output device 22 and consequently, the audio output device 22 snugly fits in the aperture 28.

FIG. 3B illustrates the audio output device 22 in the first position where it is positioned within the aperture. FIG. 3C illustrates the audio output device 22 in the second position where it is positioned for use. In this embodiment, the audio output device 22 is configured to pivot through forty five degrees between the first position and the second position. However, it should be appreciated that the audio output device 22 may pivot through more or less than forty five degrees in other embodiments. The audio output device 22 may be resiliently biased towards the first position so that the second apparatus 102 may clip to the user's head when the earpiece is placed in the user's ear.

The second apparatus 102 may include a further user input device 46 (a button for example) that is positioned at the end of the body 12 where the coupling point to the audio output device 22 is located. When the further user input device 46 is actuated by a user, the second apparatus 102 may be powered on and the audio output device 22 may be released from the first position so that it may be moved by a user.

FIGS. 4A, 4B and 4C illustrate a third apparatus 103 according to various embodiments. The third apparatus 103 is similar to the apparatus 10, the first apparatus and the second apparatus 102 and where the features are similar, the same reference numerals are used. The body 12 includes a first part 48 and a second part 50. The first part 48 includes a fastener 42 for enabling the third apparatus 103 to be fastened to a user's garment, and a cover 52. The fastener 42 may include a user input device for enabling a user to control the third apparatus 103 (as described above with reference to FIGS. 3A, 3B, and 3C). The second part 50 is similar to the first apparatus 101 illustrated in FIGS. 2A & 2B and similarly, the aperture 28 is a through hole.

The first and second parts 48, 50 of the body 12 may include a tongue and groove arrangement (not illustrated in the figures) that enables them to slide relative to one another. The first and second parts 48, 50 may be slid to three different configurations, where FIG. 4A illustrates a first configuration, FIG. 4B illustrates a second configuration and FIG. 4C illustrates a third configuration.

In FIG. 4A, the first part 48 and the second part 50 have been slid away from one another so that second part 50 extends from the first part 48 and so that the aperture 28 is not adjacent the first part 48. Consequently, the audio output device 22 may be pivoted between the first, second and third positions to enable the user to use the audio output device 22 in either of his ears.

In FIG. 4B, the second part 50 has been slid down the first part 48 (relative to the first configuration in FIG. 4A) so that their top and side edges approximately overlap one another. The cover 52 of the first part 48 covers a bottom portion of the second part 50. Where the first part 48 includes the fastener 42, the audio output device 22 may only be pivotable between the first and second positions since its movement to the third position is obstructed by the fastener 42.

In FIG. 4C, the second part 50 has been slid further down the first part 48 (relative to the second configuration in FIG. 4B) so that the cover 52 of the first part 48 covers a greater portion of the second part 50. The first part 48 includes a connector 38 (a Universal Serial Bus connector in this embodiment) that is moveable between a first position in which it is housed in the first part 48 (and not visible to a user as in FIGS. 4A and 4B) and a second position in which the connector 38 extends from the bottom of the first part 48. The movement of the second part 50 into the cover 52 of the first part 48 pushes the connector 38 out of the first part 48 so that it may be connected to another device.

FIG. 5 illustrates an exploded view of the first part 48 of the third apparatus 103 illustrated in FIGS. 4A, 4B and 4C. The first part 48 includes the connector 38, the cover 52, a loop member 54, the fastener 42 and an elongate connector member 56. The loop member 54 includes two flanges which have apertures and the fastener 42 also includes two flanges which have apertures.

In order to assemble the first part 48, the loop member 54 is connected to the fastener 42 by lining up the apertures of the flanges and then inserting the elongate connector member 56 through, the apertures. The connector 38 may then be placed inside the cover 52. The cover 52 may then be inserted into the loop member 54 so that the flanges of the loop member 54 and the fastener 42 extend around the side edges of the cover 52. The cover 52 and the loop member 54 may be coupled together via an adhesive.

FIG. 6 illustrates an exploded view of the second part 50 of the third apparatus 103 illustrated in FIGS. 4A, 4B and 4C. The second part 50 includes the audio output device 22, a first frame member 58, a second frame member 60 and a third frame member 62. The audio output device 22 includes a first member 64, a second member 66, an elongate member 68 and an earpiece part 70. The first member 64 and/or the second member 66 include a groove for receiving the elongate member 68.

In order to assemble the audio output device 22, the elongate member 68 is placed in the groove in the first and/or second member 64, 66. The first member 64 and the second member 66 are then coupled together (via an adhesive for example). The assembled first member 64, second member 66 and elongate member 66 are then placed in the earpiece part 70 so that the elongate member 68 protrudes from two apertures in the sides of the earpiece part.

The elongate member 68 of the assembled audio output device 22 is then placed in corresponding grooves in the first frame member 58 and/or in the second frame member 60. The first and second frame members 58, 60 are then coupled together (via adhesive for example) and inserted into and coupled to the third frame member 62.

FIG. 7 illustrates a perspective view of a fourth apparatus 104 according to various embodiments of the invention. The fourth apparatus 104 is similar to the first apparatus 101 illustrated in FIGS. 2A, 2B and where the features are similar, the same reference numerals are used.

The aperture 28 of the fourth apparatus 104 is configured to receive a strap 72 to enable the fourth apparatus 104 to be worn around a user's neck. The aperture 28 is dimensioned so that the strap 72 that may be threaded through the aperture 28 and then coupled together at its ends to form a loop. In various embodiments, the strap 72 may be a part of the fourth apparatus 104 and may be packaged and sold together for example. In other embodiments, the strap 72 may be separate to the fourth apparatus 104 and may be an item of jewelry possessed by the user.

A user of the fourth apparatus 104 may hang the strap 72 around a part of his body (his neck for example) in order to carry the fourth apparatus 104. The strap 72 may comprise any suitable material and may comprise, for example, plastic, fabric, or a metal such as steel, silver or gold.

FIG. 8 illustrates a flow diagram of a method of manufacturing an apparatus according to various embodiments of the invention.

At block 74, the method includes providing a body 12 including a first surface 24 defining an aperture 28. The method also includes providing an audio output device 22 configured to pivot relative to the body 12 between at least a first position in which the audio output device 22 is at least partially positioned within the aperture 28, and a second position in which the audio output device 22 extends from the first surface 24.

At block 76, the method may include providing a strap 72 which is configured to extend through the aperture 28 and be worn around a user's neck.

At block 78, the method may include providing a data input apparatus 18 which is configured to receive data from another device.

At block 80, the method may include providing a memory 116 which is configured to store data received from the data input apparatus 18.

At block 82, the method may include providing a fastener 42 which is configured to fasten the apparatus to a garment of the user.

At block 82, the method may include assembling some or all of the components of the apparatus 10, 101, 102, 103 or 104 to form a headset.

The blocks illustrated in the FIG. 8 may represent steps in a method and/or sections of code in a computer program. In particular, a processor may execute the computer program to control machinery to assemble an apparatus according to various embodiments of the invention. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed.

For example, an apparatus according to various embodiments may be configured to in part provide stereo sound. In these embodiments, the apparatus is configured to provide acoustic waves for the ear in which it is positioned in or adjacent to. Where two such apparatus are placed in the user's left and right ears, the user may experience stereo sound.

The apparatus may filter the signal received from the communication device so that the acoustic waves output from the audio output device match the ear in which the audio output device is placed in or positioned adjacent to. Where the audio output device is moveable between the first, second and third positions, the apparatus may sense the position of the audio output device to determine which ear the apparatus is placed in or adjacent to. The apparatus may use the sensed position to then filter the signal from the communication device so that output acoustic waves match the ear in which the audio output device is placed in or positioned adjacent to.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An apparatus comprising:
a body comprising a first surface defining an aperture; and
an audio output device configured to pivot relative to the body between at least a first position in which the audio output device is at least partially positioned within the aperture, and a second position in which the audio output device extends from the first surface.

2. An apparatus as claimed in claim 1, wherein the aperture is a blind aperture.

3. An apparatus as claimed in claim 1, wherein the body includes a second surface defining the aperture, and the aperture extends between the first surface and the second surface.

4. An apparatus as claimed in claim 3, wherein the audio output device is configured to pivot relative to the body to a third position in which the audio output device extends from the second surface.

5. An apparatus as claimed in claim 3, wherein the first surface has a first characteristic and the second surface has a second characteristic, different to the first characteristic.

6. An apparatus as claimed in claim 3, wherein the aperture is configured to receive a strap to enable the apparatus to be worn around a user's neck.

7. An apparatus as claimed in claim 1, further comprising a data input apparatus configured to receive data, the data input apparatus comprising one or more of: a wireless receiver configured to receive electromagnetic signals, and a connector configured to physically connect with a further apparatus to receive signals.

8. An apparatus as claimed in claim 7, further comprising a memory configured to store data received from the data input apparatus.

9. An apparatus as claimed in claim 1, further comprising a fastener configured to fasten the apparatus to a garment of a user.

10. An apparatus as claimed in claim 9, wherein the fastener comprises a user input device configured to enable a user to control the apparatus.

11. A headset comprising an apparatus as claimed in claim 1.

12. A method comprising:
providing a body comprising a first surface defining an aperture; and
providing an audio output device configured to pivot relative to the body between at least a first position in which the audio output device is at least partially positioned within the aperture, and a second position in which the audio output device extends from the first surface.

13. A method as claimed in claim 12, wherein the aperture is a blind aperture.

14. A method as claimed in claim 12, wherein the body includes a second surface defining the aperture, and the aperture extends between the first surface and the second surface.

15. A method as claimed in claim 14, wherein the audio output device is configured to pivot relative to the body to a third position in which the audio output device extends from the second surface.

16. A method as claimed in claim 14, wherein the aperture is configured to receive a strap to enable at least the body and the audio output device to be worn around a user's neck.

17. A method as claimed in claim 12, further comprising providing a data input apparatus configured to receive data, the data input apparatus comprising one or more of: a wireless receiver configured to receive electromagnetic signals, and a connector configured to physically connect with a further apparatus to receive signals.

18. A method as claimed in claim 12, further comprising providing a fastener configured to fasten at least the body and the audio output device to a garment of a user.

19. A method as claimed in claim 18, wherein the fastener comprises a user input device configured to enable a user to provide a control input.

20. A method as claimed in claim 12, further comprising assembling at least the body and the audio output device to form a head set.
